(19) United States
(12) Patent Application Publication
(10) Pub. No.: US 2026/0140566 A1
(43) Pub. Date: May 21, 2026

(54) INFORMATION HANDLING SYSTEM WITH REDUCED MODERN STANDBY FAILURE IMPACT

(71) Applicant: DELL PRODUCTS L.P., Round Rock, TX (US)

(72) Inventors: Yung-Sheng Lin, Bade District (TW); Shun-Tang Hsu, Taipei (TW); No-Hua Chuang, Taipei (TW)

(21) Appl. No.: 18/954,607

(22) Filed: Nov. 21, 2024

(51) Int. Cl. G06F 1/3296; G06F 1/3206

(52) U.S. Cl. CPC G06F 1/3296; G06F 1/3206

(57) ABSTRACT

An information handling system stores a user selectable thermal table. The system enters a modern standby. The system determines a failure to enter the modern standby. Based on the failure, the system awakes and sets to a lower power mode. The lower power mode is based on the user selectable thermal table. After the system is set to the lower power mode, the system repeats the operations to enter the modern standby.

### FIELD OF THE DISCLOSURE

The present disclosure generally relates to information handling systems, and more particularly relates to reducing modern standby failure impact within an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may store a user selectable thermal table. The system may perform operations to enter into a modern standby. The system may determine a failure to enter the modern standby. Based on the failure, the system may wake. The system may set to a lower power mode. The lower power mode is based on the user selectable thermal table. After the system is set to the lower power mode, the system may repeat the operations to enter the modern standby.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of an information handling system according to at least one embodiment of the present disclosure;

FIG. 2 is a diagram illustrating different power phases of an information handling system according to at least one embodiment of the present disclosure;

FIG. 3 is a flow diagram of a method for reducing a modern standby failure impact in an information handling system according to at least one embodiment of the present disclosure; and

FIG. 4 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

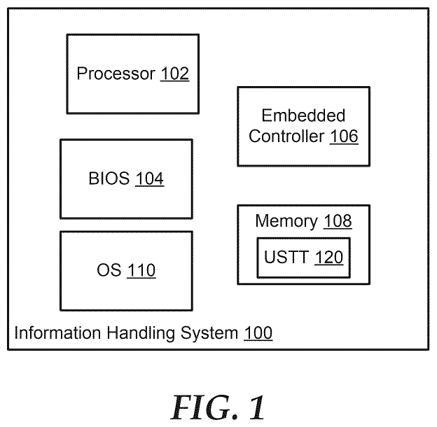

FIG. 1 illustrates an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a processor 102, a basic input/output system 104, an embedded controller 106, a memory 108, and an operating system (OS) 110. Processor 102 may execute one or more operations to execute functions of OS 110. Memory 108 may store any suitable data associated with information handling system 100 including, but not limited to, a user selectable thermal table (USTT) 120. Information handling system 100 may include additional components without varying from the scope of this disclosure.

In an example, a trigger event may occur to cause information handling system 100 to enter a modern standby (MODs) state. The trigger event may be any event including, but not limited to, a lid of information handling system 100 being closed and a user selecting a sleep mode from a graphical user interface. In certain examples, components of information handling system 100, such as processor 102, BIOS 104, embedded controller 106, and OS 110, may perform a staged approach enter the information handling system into the MODs state. In an example, these components may retry the modern-standby with each stage having a lower power and eventually force hibernation of information handling system 100.

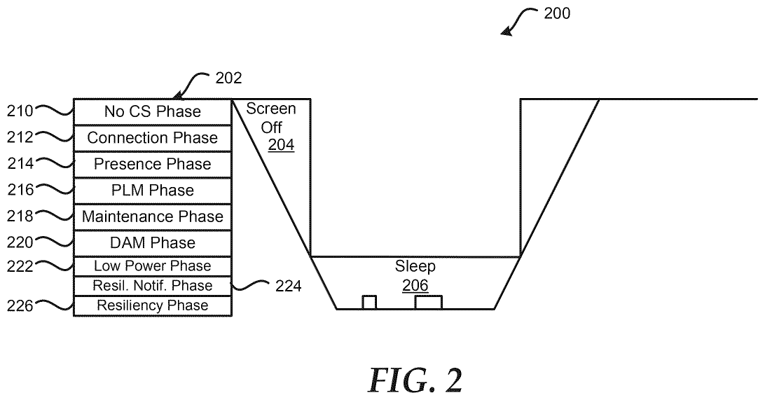

Modern standby entrance failure is not rare and may cause information handling system 100 to over heat and a depletion of battery power of the information handling system. In some situations, if information handling system 100 stays in a failure mode, this failure mode may result in a higher power consumption of the battery as compared to an information handling system that stays S0. This situation may result from a power management subsystem, such as DTT, entering a sleep mode. In response to the power management subsystem entering the sleep mode, a power management capability may be lost and cause information handling system 100 to stay in higher power mode. Information handling system 100 may be improved by processor 102, BIOS 104, and embedded controller 106 reducing modern standby failure impact within an information handling system. Operations of processor 102, BIOS 104, and embedded controller 106 in information handling system 100 will be described with respect to FIGS. 1 and 2.

FIG. 2 illustrates different power phases 200 of an information handling system, such as information handling system 100 of FIG. 1, according to at least one embodiment of the present disclosure. In an example, power phases 200 may be normal power phase 202, a screen off phase 204, and a sleep phase 206. Normal power phase 202 may include a no CS phase 210. Screen off phase 204 includes a connection phase 212, a presence phase 214, a PLM phase 216, a maintenance phase 218, and a DAM phase 220. Sleep state 206 includes a low power phase 222, a resilience phase 224, and a resiliency phase 226.

Referring back to FIG. 1, processor 102 or embedded controller 106 may detect an event to trigger entry into a MOD of information handling system 100. In an example, the event may be any suitable event including a lid of information handling system 100 being closed and a user selecting a sleep mode from a graphical user interface. Based on the event detection, the components of information handling system 100 may perform operations to enter the information handling system into MODs. In an example, the operations may include any suitable MODs entry operations including BIOS 104 and embedded controller 106 performing changes to components within information handling system 100 to reduce operational states of the components to enable MODs entry.

After a predetermined amount of time, embedded controller 106 may determine whether information handling system 100 has completed or entered the MODs. If embedded controller 106 determines that information handling system 100 has failed to enter the MODs, the embedded controller may cause a wake up of the information handling system. The wake up of information handling system 100 may include waking up both OS 110 and BIOS 104 of the information handling system. Based on the failure of information handling system 100 to enter the modern standby, processor 102 may remain in a high power state. For example, based on a power management capability not operating during the operations to enter the information handling system into the modern standby, processor 102 may remain in the high power state.

Additionally, embedded controller 106 or processor 102 may provide a MODs failure notification to a user of information handling system 100. In an example, the MODs failure notification may be provided in any suitable manner, such as a displaying a message on a graphical user interface on a display device associated information handling system 100. Additionally, embedded controller 106 may store the failure in memory 108. Embedded controller 106 may also set a thermal level of information handling system 100 to a lower thermal stage. Based on the failure of information handling system 100 to enter the MODs, embedded controller 106 may set a power level of the information handling system to a lower power mode. In certain examples, embedded controller 106 may determine the lower power mode based on the USTT 120 stored in memory 108.

In an example, USTT 120 may include the different possible power modes or phases for information handling system 100. For example, USTT 120 may include no CS phase 210, connection phase 212, presence phase 214, PLM phase 216, maintenance phase 218, DAM phase 220, low power phase 222, resilience phase 224, and resiliency phase 226 as illustrated in FIG. 2. In certain examples, the lowering of the power mode or phase may be performed in a linear manner, such that embedded controller 106 lowers the power mode or phase from a current mode to a next lower mode as indicated in USTT 120. In certain examples, USTT 120 may include data associated with the power modes or phases, such that embedded controller 106 may utilize the USTT determine a next lower power mode or phase as compared to a current power state of information handling system 100. In an example, the power modes or phases may ordered or arranged in USTT from the highest power level to the lowest power level, as illustrated in FIG. 2, from the lowest power level to the highest power level, or the like.

After embedded controller 106 has set information handling system 100 to the lower power mode, processor 102, BIOS 104, and the embedded controller may repeat the operations to enter the information handling system into the MODs. Additionally, embedded controller 106 may determine whether the operation to enter information handling system 100 into the MODs has been repeated a predetermined amount of time. In response to the operations being repeated the predetermined amount of time, embedded controller 106 may trigger the information handling system to enter into a hibernation state.

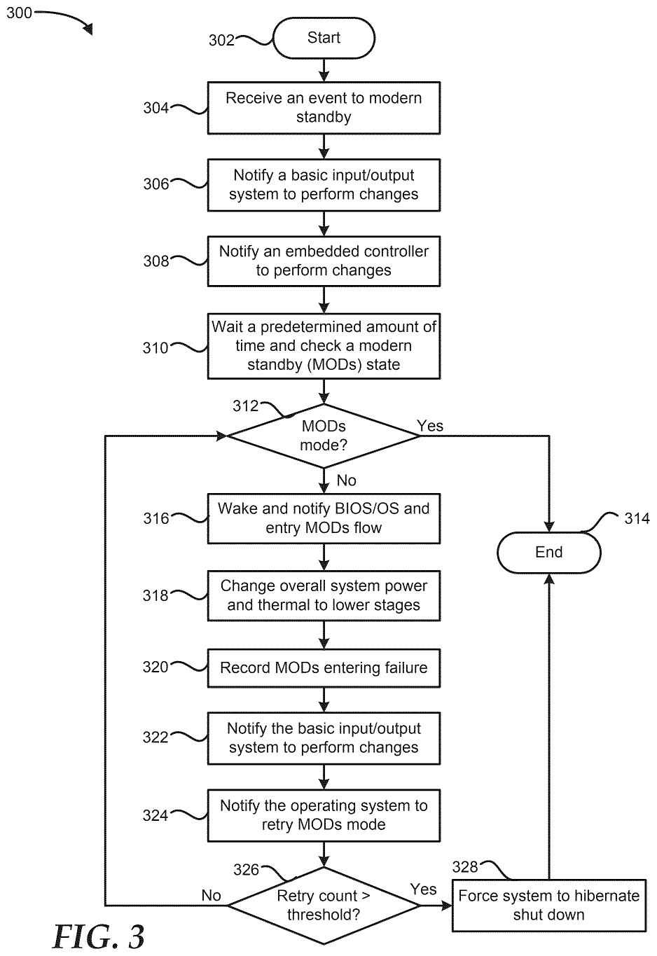

FIG. 3 is a flow diagram of a method 300 for reducing a modern standby failure impact in an information handling system according to at least one embodiment of the present disclosure, starting at block 302. It will be readily appreciated that not every method step set forth in this flow diagram is always necessary, and that certain steps of the methods may be combined, performed simultaneously, in a different order, or perhaps omitted, without varying from the scope of the disclosure. FIG. 3 may be employed in whole, or in part, processor 102, BIOS 104, and embedded controller 106 of information handling system 100 of FIG. 1, or any other type of controller, device, module, processor, or any combination thereof, operable to employ all, or portions of, the method of FIG. 3.

At block 304, an event to a modern standby (MODs) in an information handling system is received. In an example, the event may be any suitable event to trigger entry into the MODs, such as a lid on a portable information handling system being closed or the like. In certain examples, components of the information handling system, such as a processor, a BIOS, an embedded controller, and an OS, may perform a staged approach enter the information handling system into the MODs state.

At block 306, a BIOS is notified to perform changes in the information handling system. The BIOS may perform changes to components within the information handling system to reduce operational states of the components to enable MODs entry. At block 308, an embedded controller is notified to perform changes in the information handling system. At block 310, after a predetermined amount of time the MODs state is checked. At block 312, a determination is made whether the information has entered into the MODs mode or state.

If the information handling system has entered into the MODs mode, the flow ends at block 314. If the information handling system has not entered into the MODs mode, the information handling system is awakened and the BIOS and OS are notified to enter the MODs flow at block 316. In an example, waking up the information handling system may involve any suitable operation, such as waking up both an operating system and a basic input/output system of the information handling system. In an example, based on the failure of the information handling system to enter the modern standby, the processor may remain in a high power state. The processor may remain in the high power state based on a power management capability not operating during the operations to enter the information handling system into the modern standby.

At block 318, overall system power and thermal states are changes to lower stages. In an example, the lower power mode is based on the user selectable thermal table. In certain examples, the overall system power and thermal states may be lowered in a linear manner as indicated in a user selectable thermal table in the memory. At block 320, the MODs entry failure is recorded in a memory of the information handling system.

At block 322, the BIOS is notified to perform changes. The BIOS may perform changes to components within the information handling system to reduce operational states of the components to enable MODs entry. At block 324, the OS is notified to retry the entry to the MODs. At block 326, a determination is made whether a retry count is greater than a threshold. In certain examples, the threshold for the retry count may be any suitable number of retries If the entry count is not greater than the threshold, the flow continues as described above at block 312. If the entry count is greater than the threshold, the information handling system is forced into a hibernation mode or to shut down and the flow ends at block 314.

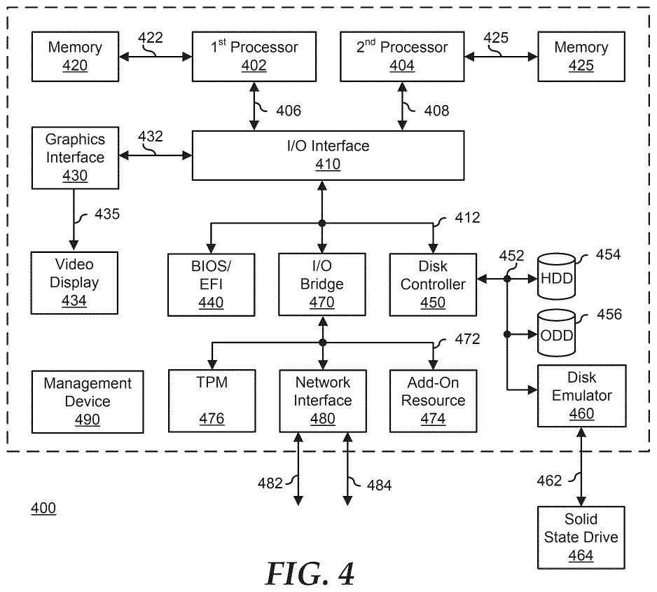

FIG. 4 shows a generalized embodiment of an information handling system 400 according to an embodiment of the present disclosure. Information handling system 400 may be substantially similar to information handling system 100 of FIG. 1. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store a user selectable thermal table; and
a processor to communicate with the memory, the processor to:
perform operations to enter the information handling system into a modern standby;
determine a failure of the information handling system to enter the modern standby;
based on the failure, the processor to:
wake up the information handling system;
set a power level of the information handling system to a lower power mode, wherein the lower power mode is based on the user selectable thermal table; and
after the information handling system is set to the lower power mode, repeat the operations to enter the information handling system into the modern standby.

2. The information handling system of claim 1, wherein the process further to:
determine whether the operation to enter the information handling system into the modern standby has been repeated a predetermined amount of time; and
in response to the operations being repeated the predetermined amount of time, trigger the information handling system to enter into a hibernation state.

3. The information handling system of claim 1, wherein based on the failure, the processor to: record the failure in the memory.

4. The information handling system of claim 1, wherein the processor to: lower the power level in a linear manner.

5. The information handling system of claim 1, wherein the wake up of the information handling system includes the processor to: wake up both an operating system and a basic input/output system of the information handling system.

6. The information handling system of claim 1, wherein based on the failure, the processor further to: set a thermal level of the information handling system to a lower thermal stage.

7. The information handling system of claim 1, wherein the processor remains in a high power state based on the failure of the information handling system to enter the modern standby.

8. The information handling system of claim 7, wherein the processor remains in the high power state based on a power management capability not operating during the operations to enter the information handling system into the modern standby.

9. The information handling system of claim 1, wherein the processor is an embedded controller of the information handling system.

10. A method comprising:
storing, in a memory of an information handling system, a user selectable thermal table;
performing, by a processor of the information handling system, operations to enter the information handling system into a modern standby;
determining a failure of the information handling system to enter the modern standby;
based on the failure:
waking up the information handling system;
setting a power level of the information handling system to a lower power mode, wherein the lower power mode is based on the user selectable thermal table; and
after the information handling system is set to the lower power mode, repeating, by the processor, the operations to enter the information handling system into the modern standby.

11. The method of claim 10, further comprising:
determining whether the operation to enter the information handling system into the modern standby has been repeated a predetermined amount of time; and
in response to the operations being repeated the predetermined amount of time, triggering the information handling system to enter into a hibernation state.

12. The method of claim 10, wherein based on the failure, the method further comprising: recording the failure in the memory.

13. The method of claim 10, further comprising: lowering the power level in a linear manner.

14. The method of claim 10, wherein the waking up of the information handling system includes the method further comprising: waking up both an operating system and a basic input/output system of the information handling system.

15. The method of claim 10, wherein based on the failure, the processor further to: setting a thermal level of the information handling system to a lower thermal stage.

16. The method of claim 10, wherein the processor remains in a high power state based on the failure of the information handling system to enter the modern standby.

17. The method of claim 16, wherein the processor remains in the high power state based on a power management capability not operating during the operations to enter the information handling system into the modern standby.

18. The method of claim 10, wherein the processor is an embedded controller of the information handling system.

19. A method comprising:
Storing a user selectable thermal table;
performing, by an information handling system, operations to enter the information handling system into a modern standby;
determining a failure of the information handling system to enter the modern standby;
based on the failure:
waking up the information handling system;
recording the failure in the memory;
setting a power level of the information handling system to a lower power mode, wherein the lower power mode is based on the user selectable thermal table;
after the information handling system is set to the lower power mode, repeating the operations to enter the information handling system into the modern standby;
determining whether the operation to enter the information handling system into the modern standby has been repeated a predetermined amount of time; and
in response to the operations being repeated the predetermined amount of time, triggering the information handling system to enter into a hibernation state.

20. The method of claim 10, wherein the waking up of the information handling system includes waking up both an operating system and a basic input/output system of the information handling system.
